(19) United States
(12) Patent Application Publication
(10) Pub. No.: US 2012/0005022 A1
(43) Pub. Date: Jan. 5, 2012

(54) METHOD, SYSTEM, AND COMPUTER-READABLE RECORDING MEDIUM FOR FLEXIBLY PARTITIONING AND PROVIDING KEYWORD ADVERTISEMENT AREA

(75) Inventor: Choong Hee Lee, Seoul (KR)

(73) Assignee: NHN BUSINESS PLATFORM CORPORATION, Seongnam-si (KR)

(21) Appl. No.: 13/148,196

(22) PCT Filed: Feb. 8, 2010
(86) PCT No.: PCT/KR10/00769

§ 371 Date: Sep. 21, 2011

(30) Foreign Application Priority Data
Feb. 6, 2009 (KR) 10-2009-0009832

(51) Int. Cl. G06Q 30/00

(52) U.S. Cl. 705/14.54; 705/14.71

(57) ABSTRACT

Disclosed herein are a method, a system, and a computer-readable recording medium for flexibly partitioning and providing a keyword advertisement area. The method for providing a keyword advertisement includes: receiving at least one bidding information for the keyword advertisement from at least one advertiser device; creating a combined advertisement slot by combining at least some of a plurality of advertisement slots of a keyword advertisement area based on the at least one bidding information; and providing at least one keyword advertisement using the combined advertisement slot and/or advertisement slots that are not combined among the plurality of advertisement slots.

### CROSS-REFERENCE TO RELATED APPLICATIONS

This application is the National Stage Entry of International Application: PCT/KR2010/000769, filed on Feb. 8, 2010, and claims priority from and the benefit of Korean Patent Application No. 10-2009-0009832, filed on Feb. 6, 2009, both of which are incorporated herein by reference for all purposes as if fully set forth herein.

### BACKGROUND OF THE INVENTION

1. Field of the Invention

Aspects of the present invention relate to a method, a system, and a computer-readable recording medium for flexibly partitioning and providing a keyword advertisement area.

2. Discussion of the Background

Recently, Internet users have been acquiring various types of information through Internet searches. That is, users have been searching for information related to news, knowledge, game, community, or the like, by accessing an Internet search site through a terminal device, such as a personal computer, or the like.

A keyword advertisement provides an advertisement associated with a search clue (for example, a search keyword) input from a user through a search site. Here, the keyword advertisement includes advertisement information, such as a uniform resource locator of an advertiser, an advertisement message, an image, or the like, to be published at a specific position on a search result page, when a user performs a search with a specific search clue, using a search engine. Since the advertisement is provided only to the users performing the search with a specific search clue, rather than being unconditionally provided to a number of unspecified users, a targeted advertisement may be provided to only potential customers relatively more likely to use a product or a service provided by the advertiser.

Keyword advertisement providers operating a search site have generally partitioned a search advertisement area into advertisement slots having fixed sizes, have published advertisements for each of the partitioned advertisement slots, and have imposed a differential advertisement cost according to a publication rank of each advertisement, in order to attract more advertisements and thereby maximize advertisement profits.

According to an existing advertisement providing scheme, since keyword advertisement formats are monotonous, even though a larger cost is paid for some slots, it is difficult to sufficiently reflect the desire of the advertiser to leave a stronger impression on users, through various advertisement representations. This disadvantage has a negative effect on the profitability of keyword advertisement providers.

### SUMMARY OF THE INVENTION

Aspects of the present invention has been proposed to solve all of the above-mentioned problems.

Aspects of the present invention provide a keyword advertisement product corresponding to payment capability of an advertiser, by flexibly partitioning a keyword advertisement area into slots of various sizes.

Another aspect of the present invention is to satisfy a desire of an advertiser to leave a strong impression on users, by allowing various keyword advertisement publication formats.

Another aspect of the present invention is to maximize the profit of a keyword advertisement provider.

According to an exemplary embodiment of the present invention, provided is a method for providing a keyword advertisement, the method including: receiving bidding information for the keyword advertisement from at least one advertiser device; creating a combined advertisement slot by combining at least some advertisement slots of a keyword advertisement area, based on the bidding information; and providing at least one keyword advertisement using the combined advertisement slot and advertisement slots that are not combined.

According to another exemplary embodiment of the present invention, provided is a method for providing a keyword advertisement, the method including: receiving bidding information for keyword advertisements from advertiser devices; determining keyword advertisement combinations published in a keyword advertisement area, based on the bidding information; and publishing an advertisement by disposing one of the keyword advertisement combinations in the keyword advertisement area including a combined advertisement slot in which at least two of a plurality of advertisement slots of the keyword advertisement area are combined.

According to another exemplary embodiment of the present invention, provided is a system for providing a keyword advertisement, the system including: a bidding information managing unit to receive bidding information for a keyword advertisement from at least one advertiser device; an advertisement slot managing unit to create a combined advertisement slot by combining advertisement slots of a keyword advertisement area, based on the bidding information; and an advertisement providing unit to provide at least one keyword advertisement using the combined advertisement slot and/or advertisement slots that are not combined.

According to another exemplary embodiment of the present invention, provided is a system for providing a keyword advertisement, the system including: a bidding information managing unit to receive bidding information for keyword advertisements from advertiser devices; and an advertisement slot managing unit to determine keyword advertisement combinations published in a keyword advertisement area, based on the bidding information, and publishing an advertisement by disposing one of the determined keyword advertisement combinations in the keyword advertisement area including a combined advertisement slot.

According to another aspect of the present invention, there are provided another method, system, computer-readable recording medium having a computer program recorded therein, for implementing the present invention, the computer program executing the method.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention:

FIG. 1 is a view schematically showing a configuration of a system for flexibly partitioning a keyword advertisement area, according to an exemplary embodiment of the present invention;

FIG. 2 is a view showing an internal configuration of a keyword advertisement system 200, according to an exemplary embodiment of the present invention.

FIGS. 3A to 3C are views showing a form in which a keyword advertisement area is flexibly partitioned, according to an exemplary embodiment of the present invention;

FIGS. 4A and 4B are illustrative views showing a method for generating combined slots, according to an exemplary embodiment of the present invention;

FIGS. 5 and 6 are illustrative views showing a form in which a display format of a keyword advertisement is changed, according to an exemplary embodiment of the present invention;

FIG. 7 is an illustrative view showing bidding information data stored in a bidding information database 250a, according to an exemplary embodiment of the present invention; and

FIG. 8 is an illustrative view showing data stored in a publishing combination database 250b.

### DETAILED DESCRIPTION OF THE ILLUSTRATED EMBODIMENTS

Exemplary embodiments of the present invention will be described in detail with reference to the accompanying drawings. These exemplary embodiments will be described in detail for those skilled in the art in order to practice the present invention. It should be appreciated that various exemplary embodiments of the present invention are different but do not have to be exclusive. For example, specific shapes, configurations, and characteristics described in an exemplary embodiment of the present invention may be implemented in another exemplary embodiment without departing from the spirit and the scope of the present invention. In addition, it should be understood that position and arrangement of individual components in each disclosed exemplary embodiment may be changed without departing from the spirit and the scope of the present invention. Therefore, a detailed description described below should not be construed as being restrictive. In addition, the scope of the present invention is defined only by the accompanying claims and their equivalents if appropriate. Similar reference numerals will be used to describe the same or similar functions throughout the accompanying drawing.

Hereinafter, exemplary embodiments of the present invention will be described in detail with reference to the accompanying drawings so that those skilled in the art may easily practice the present invention.

In the present description, a search indicates an operation of finding desired information in a database, an operation of extracting data within a local file, based on a label or a key included in a record in the local file, and an operation of obtaining specific data from a computer connected to a network in a wide sense.

In the present description, generally indicates information used to derive a search result. However, a search clue may also encompass a keyword, a category, and a position identifier obtained based a search result. A keyword may include a single word and/or a context configured of two or more words, a category, a position identifier (for example, a uniform resource locator (URL)) specified by a user.

In the present description, a keyword advertisement generally indicates an advertisement method of allowing advertisement information, such as a URL of an advertiser, an advertisement message, an image, or the like, to be published (displayed) at a specific position in a search result page, in the case in which the users perform a search with a specific search clue using a search engine.

In the present description, an advertisement slot or inventory indicates a portion of a keyword advertisement area in which an advertisement may be published. A single advertisement may be published in one or more advertisement slots.

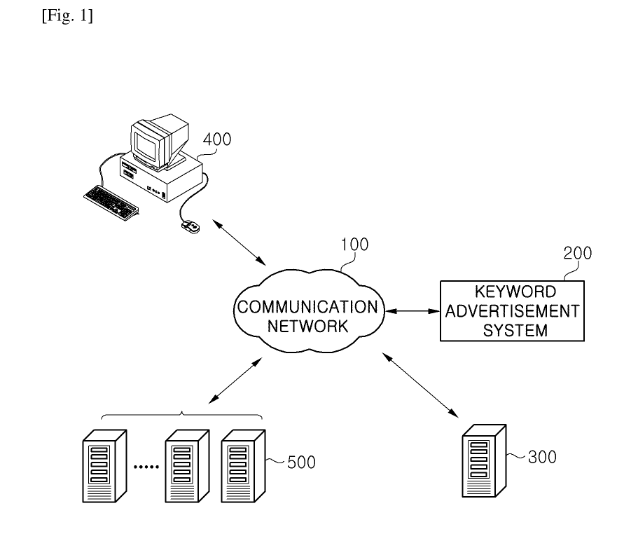

FIG. 1 is a view schematically showing the configuration of a system for flexibly partitioning a keyword advertisement area, in which advertisements are displayed, according to an exemplary embodiment of the present invention.

As shown in FIG. 1, the system includes a communication network 100, a keyword advertisement system 200, an advertiser server (or an advertiser terminal device) 300, and a user terminal device 400, and a plurality of web servers 500.

The communication network 100 may be configured for wired communications and/or a wireless communications, and may be various communication networks such as a local area network (LAN), a metropolitan area network (MAN), a wide area network (WAN), or the like. The communication network 100 may be the World Wide Web (WWW).

According to the exemplary embodiment of the present invention, the keyword advertisement system 200 displays a keyword advertisement on a search result page, according to a search clue input from the user terminal device 400.

The keyword advertisement system 200 partitions a keyword advertisement area, which an area in which a keyword advertisement is published (displayed) on the search result page, into a plurality of advertisement slots having various size and displays keyword advertisements in the advertisement slots. The keyword advertisement system 200 may operate to sell advertisement publication rights on the keyword advertisement area, to the advertiser.

The advertiser server 300 may allow the advertiser to access the keyword advertisement system 200 and then communicate therewith. However, any digital device, such as a personal computer (for example, a desktop computer, a notebook computer, or the like), a workstation, a personal digital assistance (PDA), a web pad, a mobile phone, or the like, may be used as a configuring device or an advertiser terminal device of the advertiser server 300, so long as it includes a memory unit and a micro-processer to thereby have operational capability.

More specifically, the advertiser server 300 provides advertisement information of a keyword advertisement, search clue information connected with the advertisement, information on an advertisement slot in which the advertisement information is positioned in a keyword advertisement area, and information on an advertisement cost, to the keyword advertisement system 200, through procedure such as bidding, or the like. The advertising server 300 receives a bidding result from the keyword advertisement system 200. The advertiser server 300 may also be a homepage operating server operated by the advertiser in order to provide a product or a service.

The user terminal device 400 may be a digital device that allows the user to communicate with the web server 500. The user terminal device 400 may be in the form of any of the above digital devices. In addition, the user terminal device 400 may further include a web browser (not shown) to allow the user to receive content from the web server 500.

The web server 500 communicates with the keyword advertisement system 200 and/or the user terminal device 400. For example, the web server 500 may be a search site operating server. In this case, the web server 500 includes a web content search engine (not shown), thereby making it possible to store a search clue input by the user, search content corresponding to the search clue, and allows the user to browse the search result. The search result may include information on news, knowledge, game, community, or the like. The web content search engine may also be included in other arithmetic units or recording media, rather than on the web server 500.

FIG. 1 shows a case in which the keyword advertisement system 200 and the web server 500 are separately configured. However, the keyword advertisement system 200 may also be configured to be included in the web server 500.

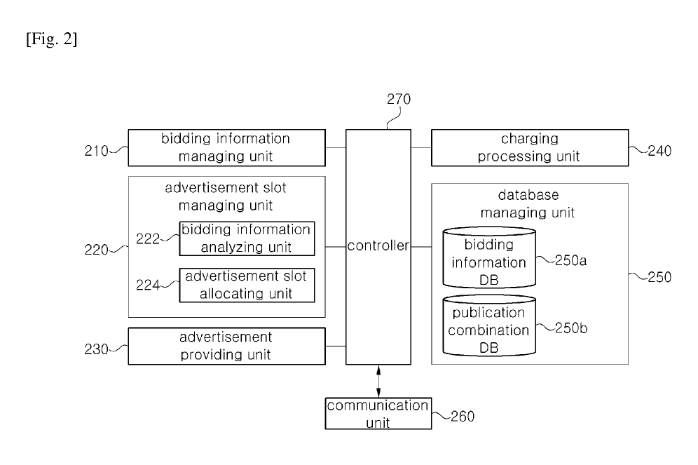

FIG. 2 is a view showing an internal configuration of the keyword advertisement system 200, according to an exemplary embodiment of the present invention in detail. Referring to FIG. 2, the keyword advertisement system 200 includes a bidding information managing unit 210, an advertisement slot managing unit 220, an advertisement providing unit 230, a charging processing unit 240, a database managing unit 250, a communicating unit 260, and a controlling unit 270. The advertisement slot managing unit 220 may include a bidding information analyzing unit 222 and an advertisement slot allocating unit 224.

At least some of the bidding information managing unit 210, the advertisement slot managing unit 220, the advertisement providing unit 230, the charging processing unit 240, the database managing unit 250, the communicating unit 260, and the controlling unit 270 may be program modules communicating with the advertiser server 300 and/or the web server 500. These program modules may be included in a form of an operating system, an application program module, and/or other program modules in the keyword advertisement system 200, and may be physically stored on several known storage devices. In addition, these program modules may also be stored in a remote storage device capable of communicating with the keyword advertisement system 200. The program modules may include a routine, a sub-routine, a program, an object, a component, a data structure, or the like, performing a specific task or executing a specific abstract data type, as described below.

The bidding information managing unit 210 receives bidding information (bid information) on the publication of a keyword advertisement from the advertiser server 300 and stores the received bidding information. When a bidding process is ended, the bidding information managing unit 210 may also inform an advertiser of a successful bid, based on a comparison with the bidding information of other advertisers.

The bidding information may include advertisement information of a keyword advertisement, search clue information corresponding to the advertisement, advertisement slot information, advertisement amount information, and the like.

The advertisement slot managing unit 220 determines a keyword advertisement to be published in a keyword advertisement area for each search clue, by analyzing bidding information of several advertisers. The advertisement slot managing unit 220 allocates an advertisement slot to a keyword advertisement determined to have a successful bid.

More specifically, the bidding information analyzing unit 222 selects a keyword advertisement for each search clue, based on the bidding information of several advertisers. Here, the bidding information analyzing unit 222 may determine a combination of keyword advertisements capable of maximizing utility of the keyword advertisement area, in consideration of the bidding information and the other information (for example, an attribute of the search clue, an attribute of the advertiser, a charging scheme, or the like).

The advertisement slot allocating unit 224 allocates the advertisement slots of the keyword advertisement area, based on the combination determined for each search clue by the bidding information analyzing unit 222.

The advertisement providing unit 230 provides the combination of the keyword advertisements determined in the advertisement slot managing unit 220 and the search result according to the search clue, to the user terminal device 400 through the web server 500, or the like.

The charging processing unit 240 performs a charging (billing) operation with respect to the keyword advertisement, based on the bidding information of the advertisers.

The database managing unit 250 includes a bidding information database 250a to store the bidding information of the advertisers and a publication combination database 250b to store the combination of the keyword advertisements to be provided together with the search result.

The communicating unit 260 enables data to be transmitted to/received from the keyword advertisement system 200.

The controlling unit 270 controls the flow of data among the bidding information managing unit 210, the advertisement slot managing unit 220, the advertisement providing unit 230, the charging processing unit 240, the database managing unit 250, and the communicating unit 260. That is, the controlling unit 270 controls the flow of data from the outside or between each component of the keyword advertisement system 200, to thereby control the operations of the bidding information managing unit 210, the advertisement slot managing unit 220, the advertisement providing unit 230, the charging processing unit 240, the database managing unit 250, and the communicating unit 260.

Although the databases storing the information for implementing the present invention therein have been classified into the bidding information database 250a and the publication combination database 250b in the above-mentioned description, a configuration of the databases including these classifications may be changed by those skilled in the art. Finally, in the present invention, the database includes a database in a broad sense including computer file system based data recording, or the like, as well as a database in a narrow sense. It should be appreciated that even a set of simple operational processing histories may be included in the database described in the present invention if it may be searched to extract a predetermined data.

According to the exemplary embodiment of the present invention, a keyword advertisement area, which is an area in which a keyword advertisement is published along with a search result, may include at least one advertisement slot. For example, when the keyword advertisement area is configured to include six advertisement slots, six or fewer different keyword advertisements may be published in the keyword advertisement area.

According to the exemplary embodiment of the present invention, an advertisement may be displayed in two or more advertisement slots, which may be disposed at spatially continuous or discontinuous positions among the advertisement slots. Therefore, the keyword advertisement area may be flexibly partitioned, so as to have various sizes.

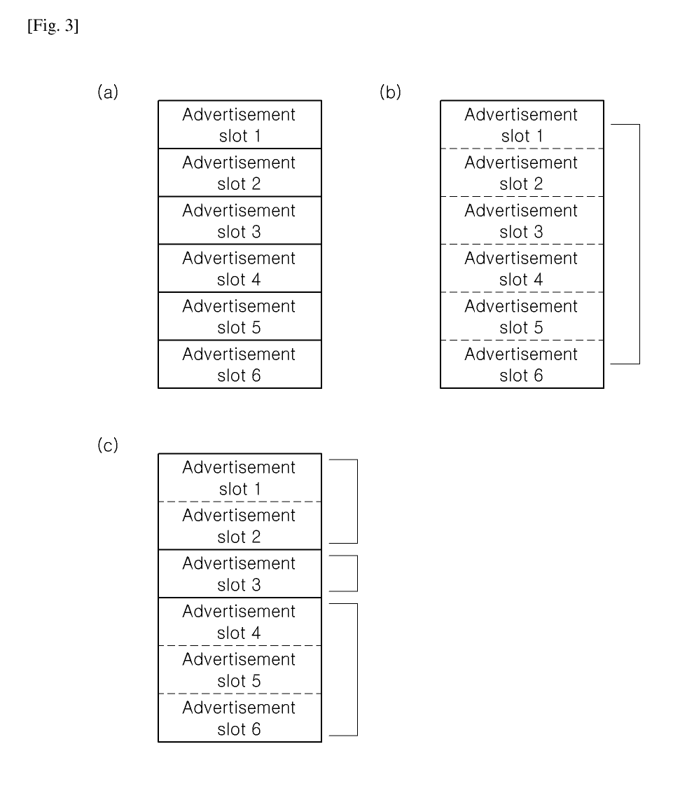

FIGS. 3A to 3C are views showing a keyword advertisement area partitioned according to an exemplary embodiment of the present invention.

FIG. 3A shows a state before advertisement slots are partitioned. Referring to FIG. 3A, the keyword advertisement area includes six advertisement slots, that is, advertisement slots 1 to 6. Referring to FIGS. 3B and 3C, various the advertisement slot configurations are shown. For example, as shown in FIG. 3B, advertisement slots 1 to 6 are merged into one advertisement slot in the keyword advertisement area. Alternatively, as shown in FIG. 3C, the advertisement slots 1 and 2 are merged into one advertisement area, in which only a single advertisement is displayed. In addition, advertisement slots 4 through 6 are also merged into an advertisement area where one advertisement is displayed.

Therefore, from user's viewpoint, the keyword advertisement area may also be flexibly partitioned as if it includes a total of three advertisement slots having different sizes. In addition, in FIG. 3C, the advertisement slots 1 and 2 and the advertisement slots 4 to 6 are merged, such that this discontinuous space may be used as a space in which only a single advertisement is displayed. Therefore, the keyword advertisement area may also be flexibly partitioned, as if it includes a total of two advertisement slots having different sizes, while being spatially spaced from each other. The shown keyword advertisement area may be partitioned in various forms, in addition the above-mentioned forms.

According to an exemplary embodiment of the present invention, advertisement slots disposed at continuous or discontinuous positions are bound or merged, that is, are combined, thereby making it possible to create combined slots to display advertisements. A combined slot may occupy a larger area than other slots.

Herein, a combined slot includes all of cases in which an advertisement is displayed in a continuous or discontinuous integrated area.

With respect to the creation of the combined slot, the keyword advertisement system 200 displays an advertisement in the combined slot, while maintaining an existing advertisement slot structure as it is, such that the target advertisement slots appear to be combined from user's viewpoint. Alternatively, the keyword advertisement system 200 may also process the slots, so as to provide a separate identifier thereto, that is, by substantially combining one or more existing slots, thereby creating a new slot having a new size, by providing a new identifier thereto.

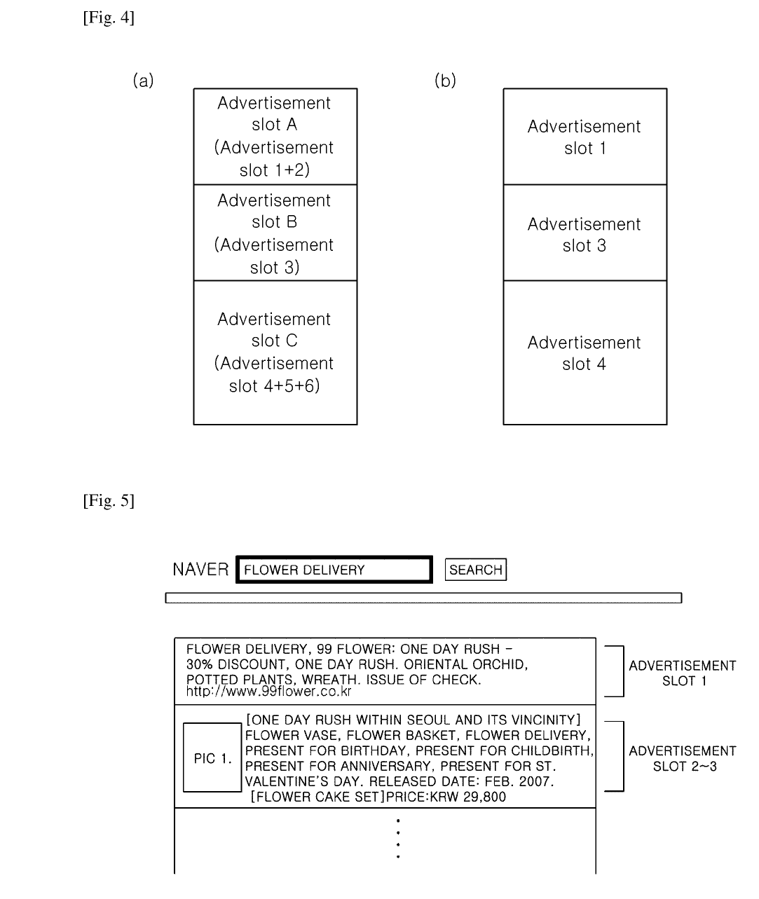

FIG. 4A shows a scheme of combining advertisement slots of an existing (original) advertisement slot structure (advertisement slots 1 to 6), to thereby create advertisement slots A, B, and C. Advertisement slot A is a combined slot that includes slots 1 and 2, slot B includes slot 3, and slot C is a combined slot that includes slots 4 to 6. As such, advertisement slots A, B, and C have three different sizes. In this case, the existing advertisement slot structure is reconfigured, such that several partitioned advertisement slots having different sizes appear from user's viewpoint.

FIG. 4B shows a scheme of providing combined slots having various sizes in a keyword advertisement area, as if the keyword advertisement area is partitioned into several advertisement slots having different sizes from user's viewpoint, while maintaining the existing advertisement slot structure. In this case, a separate identifier is not required, and several partitioned advertisement areas having different sizes are provided in the keyword advertisement area. An advertisement of a single advertisement is exposed in an integrated slot, such that the slots appear to be combined from user's viewpoint. However, this structure is different from an actual advertisement slot structure.

The combined slots may be internally created by several methods, in addition to the above-mentioned two methods. However, regardless of the method for creating the combined slots, the keyword advertisement area is partitioned into a plurality of advertisement slots capable of having various sizes.

According to an exemplary embodiment of the present invention, the respective advertisement slots and combined slots may be allocated to different advertisers, and the respective advertisers to display corresponding advertisements.

According to an exemplary embodiment of the present invention, keyword advertisement may be displayed in different formats in different slots. For example, a keyword advertisement displayed in an advertisement slot may be limited to a single line message. However, a keyword advertisement published in a combined slot may include additional information, such as an image, or the like. Further, various display formats may be used according to the number of combined advertisement slots occupied by an advertisement.

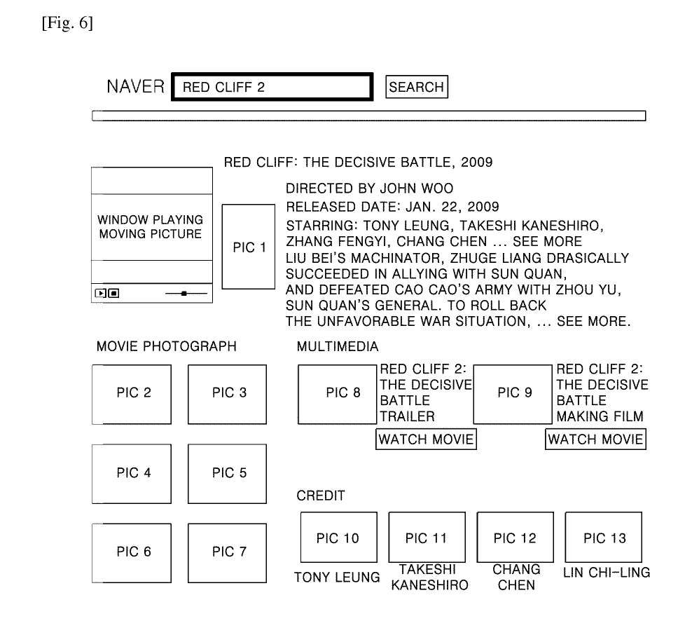

FIGS. 5 and 6 are illustrative views showing how a display format of a keyword advertisement is changed due to a combination of advertisement slots, according to an exemplary embodiment of the present invention. Referring to FIG. 5, a keyword advertisement published is a single advertisement slot may include advertisement information text as shown. However, the advertisement may include text and an image.

As the number of combined advertisement slots increases, types of advertisement information that may be included in the search advertisement becomes various. FIG. 6 illustratively shows a form in which a single keyword advertisement is published in a single advertisement slot created by combining six advertisement slots. Referring to FIG. 6, it may be confirmed that advertisement information created in various schemes using a window playing a moving picture, an image, a text, and the like, may be included in the keyword advertisement published in the combined slots.

According to an exemplary embodiment of the present invention, an advertiser may purchase a right of publishing (publishing rights) to a keyword advertisement, while specifying search clues, the number, positions, or the like, of the advertisement slots in which the keyword advertisement is published. The publishing rights may be sold in a scheme such as online auction, or the like. That is, this may be a scheme in which when an advertise inputs a bid amount, and a keyword advertisement to be published on a search result page is determined based on the bid amount.

According to an exemplary embodiment of the present invention, the bidding information managing unit 210 may provide an interface enabling the advertiser to participate in an auction procedure, for the publishing rights of the keyword advertisement on the advertiser server 300 and receive bidding information from the advertiser through the interface.

More specifically, the bidding information managing unit 210 may provide the interface including a function (operation) enabling the advertiser to input the advertisement information of the keyword advertisement, a function enabling the advertiser to specify the search clue, a function enabling the advertiser to input information on the advertisement slot, a function enabling the advertiser to input a bidding amount, and the like, to the advertiser server 300. Therefore, for example, the advertiser may specify advertisement slots N to M (N and M indicate natural numbers and M≧N) with respect to a search keyword called K and bid an amount A for the specified advertisement slots. As another example, the advertiser may specify at least one of advertisement slots partitioned into L (L indicates natural numbers) with respect to a search keyword called J (may specify each of positions of discontinuous advertisement slots in a scheme of 1, L-3, and L) and bid an amount B for the specified advertisement slot.

The information on the advertisement slot may be input by allowing the advertiser to input advertisement slot positions and/or the number of the advertisement slots to be occupied by the keyword advertisement in the keyword advertisement area on the search result page associated with a specific search clue. For example, when the keyword advertisement includes relatively simple advertisement information, such as text, the advertiser may specify the number of advertisement slots. When the advertiser wants to include more advertisement information in a keyword advertisement, he/she may specify the number of advertisement slots as two or more. Furthermore, the advertiser may specify the position of the advertisement slot. For example, the advertiser may want to have a higher position than that of keyword advertisements of other advertisers, in the keyword advertisement area. As such, the advertiser may participate in an auction to secure a specific advertisement slot position.

The interface provided by the bidding information managing unit 210 may transmit an advertisement information template that is preset according to a number of advertisement slots, to the advertiser server 300. Therefore, the advertiser may more easily create and input the advertisement information.

The bidding information managing unit 210 may connect the bidding information of the advertiser with identification information of the advertiser and store the connected information in the bidding information database 250a.

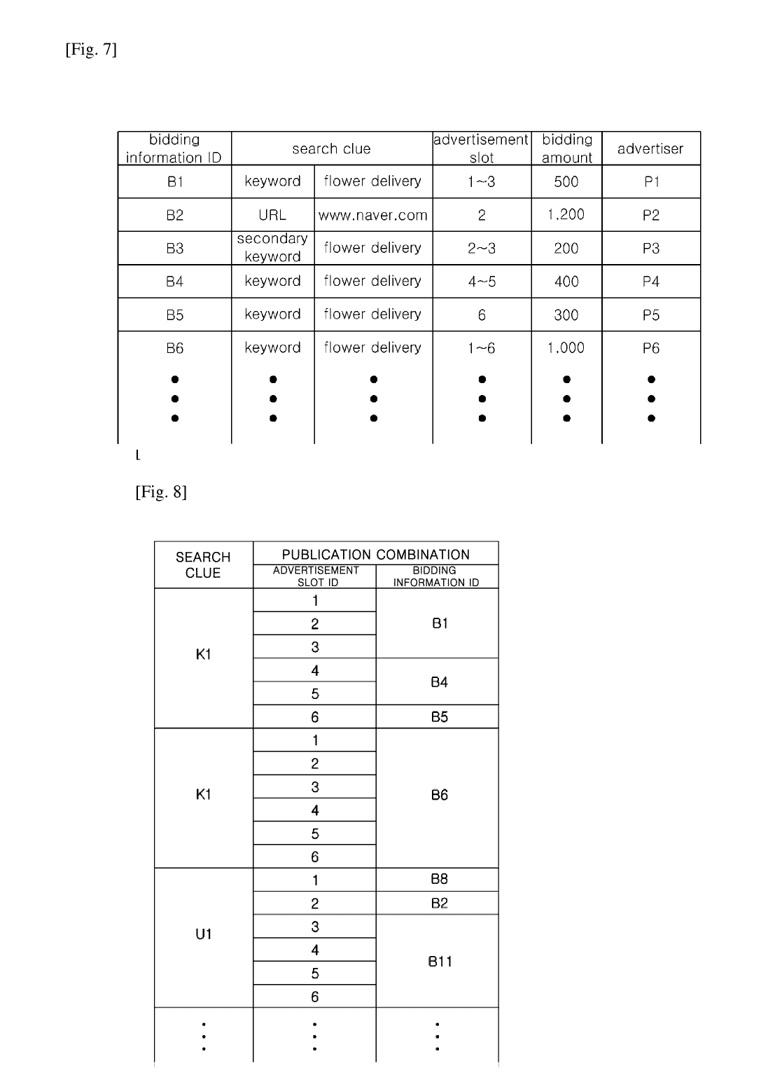

FIG. 7 is an illustrative view showing bidding information data stored in a bidding information database 250a, according to an exemplary embodiment of the present invention. Referring to FIG. 7, bidding information B1 is associated with bidding specifying advertisement slots 1 to 3, with respect to a search keyword “flower delivery”, and bidding information B2 is associated with bidding specifying only an advertisement slot 2 with respect to URL “www.naver.com”. Bidding information B3 is associated with bidding with respect to “flower delivery”, which is a secondary keyword. Here, the secondary keyword indicates a keyword derived in association with content primarily used in the user terminal device 400. Although not shown in FIG. 7, bidding in which the advertisement slots are discontinuously selected (for example, advertisement slots 4 and 6 are selected) may be performed.

The advertisement slot managing unit 220 may determine a combination (order) of the keyword advertisements to be published in the keyword advertisement area for each search clue, by analyzing the bidding information. More specifically, the bidding information analyzing unit 222 may classify the bidding information stored in the bidding information database 250a for each search clue and then extract each combination (hereinafter, referred to as a “relative prime combination”) for all cases of the bidding information on the keyword advertisements, among the bidding information connected with the same search clue.

Describing the relative prime combination in more detail with reference to FIG. 7, the shown bidding information B1, B4, and B5 are associated with bidding for the search keyword “flower delivery”. However, the advertisement slots 1 to 3 are specified in the bidding information B1, the advertisement slots 4 and 5 are specified in the bidding information B4, and the advertisement slot 6 is specified in the bidding information B5. Therefore, since the advertisement information of the keyword advertisements according to the bidding information B1, B4, and B5 may be published in a single keyword advertisement area (that is, there is no advertisement slot overlapped with each other among the advertisement slots to be occupied by the advertisement information of three keyword advertisements), a combination of {B1, B4, B5} may be called a relative prime combination.

In the shown case, {B6} may also be called a relative prime combination. Unless all advertisement slots included in the search advertisement area need not to be filled with the search advertisements, {B1}, {B1, B4}, {B4, B5}, and the like, may also be called a relative prime combination. That is, in FIG. 7, all relative prime combinations for the search keyword “flower delivery” may be {B1}, {B4}, {B5}, {B6}, {B1, B4}, {B1, B5}, {B4, B5}, and {B1, B4, B5}. On the other hand, {B1, B6}, {B4, B6}, {B1, B4, B6}, and the like, are not a relative prime combination.

Although FIG. 7 shows a case in which the advertiser specifies the position of the advertisement slot, in the case in which the advertiser may specify only the number of advertisement slots, more relative prime combinations may be generated. In this case, any combinations that do no exceed the total number of advertisement slots (allocated with respect to a specific search clue) may be classified as relative prime combinations.

The bidding information analyzing unit 222 may select at least one combination among relative prime combinations extracted for each search clue, as a publication combination to be published in a keyword advertisement area associated with a corresponding search clue. Therefore, an operation of selecting the publication combination among the relative prime combinations may be performed according to various criteria.

The publication combination may be selected according to a criterion in which economical utility of the keyword advertisement area is maximized. That is, the relative prime combinations are arranged according to the order of the economical utility, and n relative prime combinations having high economical utility may be selected as the publication combinations. A detailed description thereof will be provided with reference to FIG. 6. In the case of a relative prime combination {B6} for a search clue “flower delivery”, the sum of a bidding amount is 1,000 Won. On the other hand, in the case of a relative prime combination {B1, B4, B5}, the sum of a bidding amount is 1,200 Won (500 Won+400 Won+300 Won). Therefore, it may be confirmed that the relative prime combination {B1, B4, B5} has a larger economical utility than that of the relative prime combination {B6}. As a result, {B1, B4, B5} may be prioritized as the publication combination, as compared to {B6}.

A bidding amount included in the bidding information may be an amount according to at least one of: a cost per millennium (CPM) scheme, in which an advertisement cost is calculated according to the number of advertisement displays to users; a cost per time (CPT) scheme, in which an advertisement cost is calculated based on a time during which an advertisement is published; a cost per click (CPC) scheme, in which an advertisement cost is calculated according to the number of selections and clicks of advertisement information by users; and a cost per action (CPA) scheme, in which an advertisement cost is calculated according to an action result (for example, purchase of a product through a search advertisement) of users. The scheme of measuring the economical utility in consideration of only the bidding amount as described above may be more appropriate for the CPM scheme or CPT scheme.

According to the exemplary embodiment of the present invention, when the CPC scheme or the CPA scheme is adopted, the economical utility may be calculated by additionally considering information that is not included in the bidding information. More specifically, in the case of the CPC scheme, since a bidding amount (in fact, in this case, a bidding unit cost) is an advertisement cost imposed on the advertiser whenever the users click the advertisement information, it is slightly difficult to determine whether or not the economical utility is maximized. The reason is that in the case in which even though a bidding amount itself is high, the number of clicks of corresponding advertisement information by the users is low (that is, a user attracting effect is low) or the number of actions actually taken by the user through a corresponding search advertisement is low (that is, a purchase inducing effect is low), the economical utility may become low. Therefore, a weight may be provided to the bidding information according to a degree to which the keyword advertisement or a web site of the advertiser attracts the click by the users or induces an actual action of the users.

The weight provided to the bidding information in the CPC scheme or the CPA scheme may be determined using existing historical information stored in the keyword advertisement system 200. That is, after existing histories of advertisers bidding for auction that is currently performed are examined, a higher weight may be provided to bidding information of an advertiser that has recorded a higher click-through rate (CTR) or conversion rate (CR) in the past. Here, as the simplest method, a method of using the CTR or the CR itself recognized through the existing histories as the weight of the corresponding bidding information may be assumed. Meanwhile, with respect to the bidding information of the advertiser on which the existing history may not be recognized, an average value of the CTR or the CR for a corresponding search clue may also be used as an estimation weight.

The publication combination may be determined in consideration of an attribute of the search clue, as well as with the above-mentioned the economical utility. For example, in the case of a search clue popular with several advertisers (for example, a popular keyword, a URL of an initial screen, or the like) or a search clue in which it is required to ensure diversity of selection to the user (for example, a search keyword such as “pensions”, “restaurants”, or the like), when only economical utility is considered, some advertisers having high financing capability, such as a large enterprise, or the like, exclusively secure the right of publishing the advertisement. As such, dissatisfaction of general advertisers may increase and customer options may be limited. Therefore, in this case, the selection of the publication combination may be changed.

More specifically, assuming that three publication combinations are selected, one of three publication combinations may be selected in consideration of the economical utility, and the remaining two publication combinations may be selected to provide the publishing rights to more advertisers. As another method, with respect to the popular search keyword, the advertiser may also be forced to participate in the auction, by specifying only the advertisement slots less than a predetermined number.

According to the exemplary embodiment of the present invention, the publication combination may be determined by additionally considering the attributes of the advertisers participating in the bidding. For example, a low weight may be provided to bidding information of an advertiser that frequently violates an advertisement operation policy of the keyword advertisement system 200, or a high weight may be provided to bidding information of an advertiser that continuously publishes a search advertisement using the keyword advertisement system 200.

The bidding information analyzing unit 222 may store the information on the publication combination determined according to the above-mentioned method, in the publication combination database 250b.

FIG. 8 is an illustrative view showing data stored in a publishing combination database 250b. Referring to FIG. 8, each of the publication combinations (that is, {B1, B4, B5}, {B6}, {B8, B2, B11}) determined by the bidding information analyzing unit 222 are stored in connection with information on corresponding search clues and advertisement slots. Meanwhile, in FIG. 8, even though a search clue K1 is a single search clue, it is stored in connection with a plurality of publication combinations.

Criteria for selecting the publication combinations as described above, that is, the economical utility, the attribute of the search clue, the attribute of the advertiser, or the like, may also be referenced to determine a final publication rank of several keyword advertisement corresponding to the selected publication combinations.

The exemplary embodiments according to the present invention described above are implemented in a form of program commands capable of being performed through various computer components to thereby be recordable in a non-transitory computer-readable recording medium. The computer-readable recording medium may include program commands, data files, data structures, or the like, alone or in combination. The program command recorded in the computer-readable recording medium may be designed and configured especially for the present invention, or may be known to those skilled in a field of computer software. Example of the computer-readable recording medium may include a magnetic medium such as a hard disk, a floppy disk, and a magnetic tape; an optical recording medium such as a CD-ROM, a DVD; a magneto-optical medium such as a floptical disk; and a hardware device specially configured to store and perform program commands such as a ROM, a RAM, a flash memory, or the like. Examples of the program commands may include machine language codes such as being made by compilers as well as high-level language codes capable of being executed by computers using interpreters or the like. The hardware device may be configured to be operated as one or more software modules in order to perform the process according to the present invention, and vice versa.

As set forth above, according to the exemplary embodiments of the present invention, it is possible to provide the keyword advertisement product corresponding to payment capability of an advertiser, by flexibly partitioning and providing the keyword advertisement area, so as to have various sizes from user's viewpoint.

According to the exemplary embodiments of the present invention, it is possible to satisfy a desire to leave a strong impression on users, by allowing various keyword advertisement publication formats.

According to the exemplary embodiments of the present invention, it is possible to maximize profits of a keyword advertisement provider.

Hereinabove, although the present invention is described by specific matters such as concrete components, and the like, exemplary embodiments, and drawings, they are provided only for assisting in the entire understanding of the present invention. Therefore, the present invention is not limited to the exemplary embodiments. Various modifications and changes may be made by those skilled in the art to which the present invention pertains from this description.

1. A computer implemented method for providing a keyword advertisement, the method comprising:
receiving bidding information of a first keyword advertisement, from an advertiser device;
creating a combined advertisement slot by combining advertisement slots of a webpage, based on the bidding information; and
using the computer to display the first keyword advertisement in the combined advertisement slot.

2. The method of claim 1, wherein the bidding information comprises at least one of a search clue, a position at which the keyword advertisement is displayed in the keyword advertisement area, and the number of advertisement slots.

3. The method of claim 2, wherein the search clue comprises at least one of a keyword, a category, and a position identifier.

4. The method of claim 1, wherein the combined advertisement slot is created by combining at least two continuous or discontinuous advertisement slots.

5. The method of claim 1, further comprising displaying other keyword advertisements in one or more of the remaining advertisement slots,
wherein the display format of the first keyword advertisement is different from the display format of the other keyword advertisement.

6. The method of claim 5, wherein the display format of the first keyword advertisement is determined according to the size and shape of the combined advertisement slot.

7. A computer implemented method for providing a keyword advertisement, the method comprising:
receiving bidding information of keyword advertisements, from advertiser devices;
determining keyword advertisement combinations, based on the bidding information, each combination comprising keyword advertisements corresponding to different advertisement slots of a webpage; and
using the computer to display the advertisements of one of the combinations in the corresponding advertisement slots, such that at least one of the advertisements is displayed in a combined advertisement slot comprising at least two of the advertisement slots.

8. The method of claim 7, wherein the bidding information of each advertisement comprises a search clue, a desired advertisement slot, and a bid amount.

9. The method of claim 8, wherein the determining of the keyword advertisement combinations comprises determining a relative prime combination comprising keyword advertisements that can each be concurrently displayed in different corresponding advertisement slots.

10. The method of claim 8, wherein the determining of the keyword advertisement combinations comprises using at least one of bidding amounts of the of bidding information, an attribute of the search clue, advertiser historical information, and advertiser attributes.

11. A system for providing a keyword advertisement, the system comprising:
a bidding information managing unit to receive bidding information for the keyword advertisement, from an advertiser device;
an advertisement slot managing unit to create a combined advertisement slot by combining advertisement slots of a keyword advertisement area based on the bidding information; and
an advertisement providing unit to display the keyword advertisement in the combined advertisement slot.

12. The system of claim 11, wherein the bidding information comprises a search clue, a display position of the keyword advertisement.

13. The system of claim 12, wherein the search clue comprises at least one of a keyword, a category, and a position identifier.

14. The system of claim 11, wherein the combined advertisement slot comprises at least two continuous or discontinuous advertisement slots.

15. The system of claim 12, wherein the display format of the keyword advertisement in the combined advertisement slot is different from that of keyword advertisements displayed in other ones of the advertisement slots.

16. The system of claim 15, wherein the display format of the keyword advertisement in the combined advertisement slot is determined according to the shape and size of the combined advertisement slot.

17. A system for providing a keyword advertisement, the system comprising:
a bidding information managing unit to receive bidding information for keyword advertisements from advertiser devices; and
an advertisement slot managing unit to determine keyword advertisement combinations, based on the bidding information, each combination comprising keyword advertisements corresponding to different advertisement slots of a webpage, and to display the advertisements of one of the combinations in the corresponding advertisement slots, such that at least one of the advertisements is displayed in combined advertisement slot comprising at least two of the advertisement slots.

18. The system of claim 17, wherein each of the bid information comprises a search clue, a display position of corresponding keyword advertisement in a keyword advertisement area, and a bid amount.

19. The system of claim 18, wherein the keyword advertisement combinations comprise a relative prime combination.

20. The system of claim 18, wherein the advertisement slot managing unit further consider at least one of bidding amounts of the bidding information, an attribute of the search clue, historical information on advertisers, and attributes of the advertisers, when determining the combination to be displayed.

21. A computer readable recording medium having a computer program recorded therein to execute the method of claim 1.
